(19) United States
(12) Patent Application Publication
(10) Pub. No.: US 2025/0148503 A1
(43) Pub. Date: May 8, 2025

(54) ANALYSIS AND ATTRIBUTION TOOL FOR MONITORING PODCAST AUDIENCE ENGAGEMENT

(71) Applicant: Swap.fm Inc., New York, NY (US)

(72) Inventors: Christopher Enriquez, New York, NY (US); Arjun Madgavkar, Miami, FL (US); William Mathews, Brooklyn, NY (US)

(21) Appl. No.: 18/936,815

(22) Filed: Nov. 4, 2024

Related U.S. Application Data
(60) Provisional application No. 63/595,660, filed on Nov. 2, 2023.

(51) Int. Cl. G06Q 30/0242

(52) U.S. Cl. CPC G06Q 30/0246

(57) ABSTRACT

A method for prompting a podcast includes receiving a feed swap request from a first user, the feed swap request including a first feed to be swapped with a second feed provided by a second user, placing the first feed in a second hosting platform associated with the second user, adding a first tracking tool for the first feed to the second hosting platform when placing the first feed in the second hosting platform, collecting, through the first tracking tool, a first set of user engagements with the first feed for a first period of time, and generating a first actionable insight for the first user based on the collected first set of user engagements with the first feed.

### CROSS-REFERENCE TO RELATED APPLICATION

This application claims the benefit of and priority to the U.S. Provisional Patent Application No. 63/595,660, filed on Nov. 2, 2023, and titled “ANALYSIS AND ATTRIBUTION TOOL FOR MONITORING PODCAST AUDIENCE ENGAGEMENT,” the entire content of which is incorporated herein by reference in its entirety.

### TECHNICAL FIELD

This application generally relates to the field of podcast management, and more particularly to analysis and attribution tools for monitoring podcast audience engagement.

### BACKGROUND

Podcasting is the distribution of audio or video files, such as radio programs or music videos, over the Internet using either RSS or Atom Syndication for listening on mobile devices and personal computers. A podcast is a web feed of audio or video files placed on the Internet for anyone to download or subscribe to. A podcaster's website or channel may offer direct download of their files, but the subscription feed of automatically delivered new content is what distinguishes a podcast from a simple download or real-time streaming. Usually, a podcast features one type of “show” with new episodes either sporadically or at planned intervals such as daily, weekly, etc. Besides that, there are podcast networks that feature multiple shows on the same feed. Podcasting's essence is about creating content (audio and/or video) for an audience that wants to listen when they want, where they want, and how they want.

Tracking podcast audience engagement is essential for understanding audiences' preferences, behaviors, and feedback. This can help improve content quality and relevance by recognizing what topics, formats, and styles are resonating with a podcast's audience. Additionally, it can help grow podcast reach and influence by identifying a podcaster's most loyal and active listeners and encouraging these listeners to spread the word about the podcaster's show. A podcaster can also leverage the data and insights to demonstrate his/her value to sponsors, advertisers, and partners as the podcaster monetizes his/her podcast better.

Measuring and analyzing podcast audience engagement can sometimes be challenging, as different podcasts may have hosting platforms, which may have different data formats for further processing, such as analysis. Accordingly, there is a need for a tracking mechanism that can be used to measure podcast audience engagement across different platforms.

### SUMMARY

To address the aforementioned shortcomings, a method and system for monitoring podcasts are provided. The method includes receiving a feed swap request from a first user, the feed swap request including a first feed to be swapped with a second feed provided by a second user, placing the first feed in a second hosting platform associated with the second user, adding a first tracking tool for the first feed to the second hosting platform when placing the first feed in the second hosting platform, collecting, through the first tracking tool, a first set of user engagements with the first feed for a first period of time, and generating a first actionable insight for the first user based on the collected first set of user engagements with the first feed.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 is a block diagram of an example architecture for a podcast audience engagement monitoring system, according to embodiments of the disclosure.

FIG. 2 illustrates example components included in podcast monitoring tools, according to embodiments of the disclosure.

FIG. 3A illustrates an example application scenario of a tracking prefix, according to embodiments of the disclosure.

FIG. 3B illustrates an example flow diagram of tracking prefix-based podcast monitoring, according to embodiments of the disclosure.

FIG. 4 illustrates an example process for implementing a tracking pixel on a podcast ad, according to embodiments of the disclosure.

FIG. 5 illustrates an example process for implementing a promo swap, according to embodiments of the disclosure.

FIG. 6 is a flow chart of an example method for feed swap, according to embodiments of the disclosure.

FIG. 7 is a block diagram of an example computer for a podcast audience engagement monitoring system, according to embodiments of the disclosure.

### DETAILED DESCRIPTION

The figures (FIGS.) and the following description relate to some embodiments by way of illustration only. It is to be noted that from the following description, alternative embodiments of the structures and methods disclosed herein will be readily recognized as viable alternatives that may be employed without departing from the principles of the present disclosure.

Reference will now be made in detail to several embodiments, examples of which are illustrated in the accompanying figures. It is to be noted that wherever practicable similar or like reference numbers may be used in the figures and may indicate similar or like functionality. The figures depict embodiments of the disclosed system (or method) for illustrative purposes only. One skilled in the art will readily recognize from the following description that alternative embodiments of the structures and methods illustrated herein may be employed without departing from the principles described herein.

The present disclosure addresses the aforementioned problems and other problems in tracking podcast audience engagement by providing a podcast audience engagement monitoring system that includes certain tools for tracking podcast audience engagement and includes certain algorithms or models for further analysis and generating certain recommendations based on the analysis. According to some embodiments, the disclosed system may also include a podcast swap dashboard(s) created to facilitate podcast swaps, resulting in a larger audience pool for a podcaster's show.

According to some embodiments, the podcast audience engagement monitoring system may include a specifically configured tracking prefix, which may be added to different hosting platforms, to allow to track user engagement activities of the audiences with these hosting platforms. In one example, when such a tracking prefix is added to a hosting platform, during the tracking process, when a user requests to engage with a podcast in the hosting platform, the user request may be routed to the disclosed system for tracking purposes. Thereafter, the disclosed system may direct the user request to the actual hosting platform for user engagements with the hosting platform. In this way, user engagement activities with the hosting platform may be timely tracked.

According to some embodiments, the podcast audience engagement monitoring system may also include a specifically configured tracking pixel, which may be also added to different hosting platforms, to allow to track user engagement activities of the audiences with various hosting platforms. In one example, when a user agrees to run a swap advertisement with another user, a tracking pixel may be generated and added to the corresponding hosting platform(s). Every time a podcast listener hears an advertisement, a request is made to the disclosed system to register the action of the podcast listener. This tracking allows the disclosed system to track data around advertisement conversions and impressions, among other possible activities performed by the podcast listener.

According to some embodiments, the podcast audience engagement monitoring system may also generate one or more dashboards that facilitate a podcaster to swap his/her podcasts with other podcasters to increase the audience pool. Depending on the user profile, the disclosed system may generate a dashboard that lists all or only some podcasts that are connected with the disclosed system. For example, by listing all podcasts in a dashboard, the disclosed system may allow a podcaster to select any podcast(s) that the podcaster desires to swap. Additionally or alternatively, by listing only some of the podcasts in a dashboard, the disclosed system may allow a podcaster to select podcasts that have common features (e.g., within a same enterprise, organization, etc.) for podcast swap. The specific processes of podcast swapping are further described in detail later.

In some embodiments, the podcast audience engagement monitoring system may further include algorithms configured to analyze user engagement activities. For example, based on the tracked user activities, the algorithms included in the disclosed system may further check whether a listener listens to the whole show, skips parts, or drops off early, whether a listener leaves feedback, shares the content, or subscribes to the channel, and so on. These are some exemplary questions that the podcast audience engagement metrics can help answer. In some embodiments, additional analyses may be also implemented by the disclosed system, which include but are not limited to visibility analysis, promotion analysis, and other different analyses, as will be described in detail later.

In some embodiments, the podcast audience engagement monitoring system may also include algorithms configured to generate different recommendations for podcasters. These recommendations may be generated based on the various analyses, and may help a podcaster to improve its audience by improving the quality and/or relevance of podcasts themselves and/or by optimizing the marketing strategy (e.g., identifying more proper podcasters for podcast swaps).

It is to be noted that the features and advantages described herein are not all-inclusive, and many additional features and advantages will be further described under the context of specific embodiments. In addition, some additional features and advantages will become apparent to one of ordinary skill in the art in view of the following detailed descriptions.

### Overall System

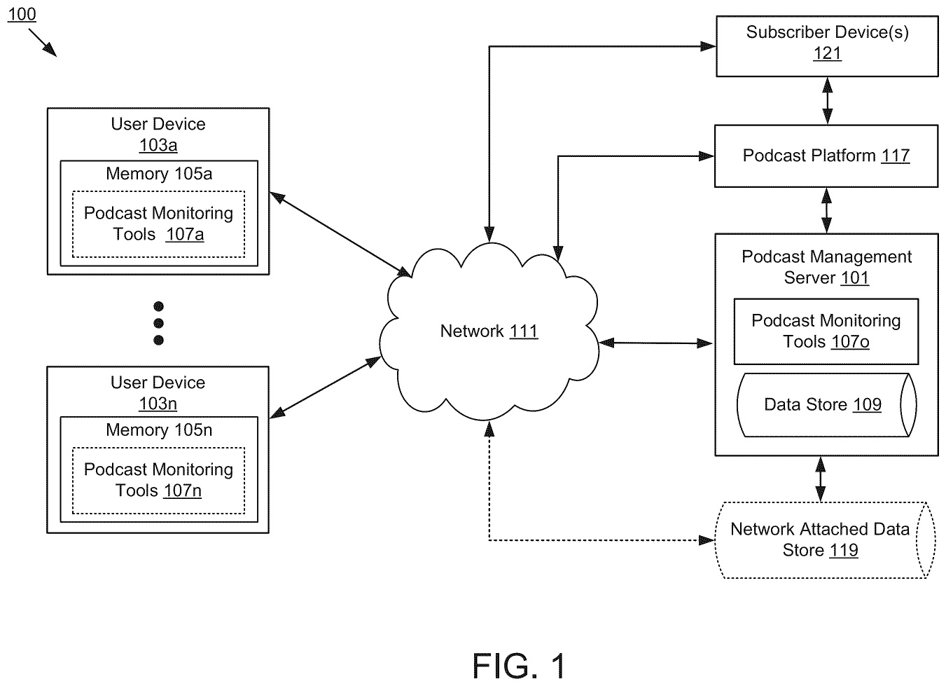

FIG. 1 is a block diagram of an example podcast audience engagement monitoring system 100, according to embodiments of the disclosure. The podcast audience engagement monitoring system 100 may be a network-based specialized computer environment for monitoring the podcast related activities including tracking audience engagement with podcasts.

As illustrated in FIG. 1, the podcast audience engagement monitoring system 100 may include one or more user devices 103a . . . 103n, which can be specialized computers or other machines that are specifically configured to provide user inputs for configuring certain tracking tools and for displaying certain podcasts in a way convenient for management of podcasts. In one example, the user devices 103a . . . 103n (together or individually referred to as “user device 103”) may be associated with different users such as podcasters, where each user may distribute certain audio or video files. In one example, the user device 103a is associated with user A and the user device 103n is associated with user N, each of which may use the respective user device to prepare audio or video files for distribution using RSS feeds to the devices of subscribed users. In another example, user A and user N may conduct a podcast swap to promote each other's podcasts so that their respective podcasts can reach a larger audience.

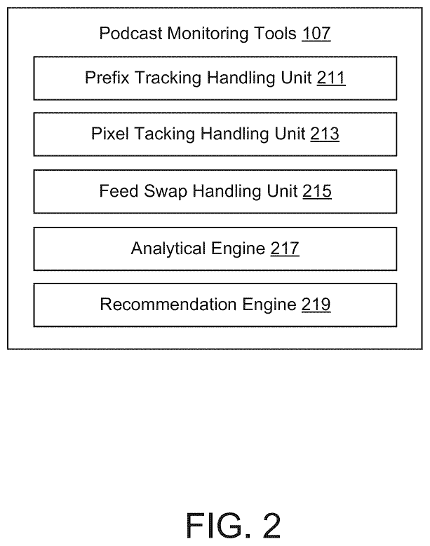

In addition, in some embodiments, each specialized computer or user device 103 may be configured to implement some or all functions related to the disclosed monitoring of audience engagement with podcasts. For example, each user device 103 may optionally include one or more podcast monitoring tools 107a or 107n (together or individually referred to as “podcast monitoring tools 107”), where each tool may be configured to perform certain functions related to the monitoring of audience engagement with podcasts. For example, the podcast monitoring tools 107 may include a first tool for tracking user activity, a second tool for analyzing the tracked user activities, and a third tool for generating recommendations based on the analysis, etc. The specific functions of these monitoring tools are further described with reference to FIG. 2.

As shown in FIG. 1, the podcast audience engagement monitoring system 100 may additionally include a podcast management server 101. According to some embodiments, the podcast management server 101 may sit between user devices 103 and a podcast platform 117. By configuring a podcast management server 101 in the podcast audience engagement monitoring system 100, it allows certain tracking tools to be implemented when submitting a podcast to the podcast platform for distribution. In addition, in some embodiments, the podcast management server 101 may be also configured to receive user activities (or subscriber activities) from subscriber device(s) 121 on the podcast platform 117. In some embodiments, the podcast monitoring tools 1070 such as tools for user activity analysis and for generating recommendations based on the analysis may be also included in the podcast management server 101. In other words, certain podcast management functions may be implemented on the podcast management server 101 and may be implemented on a user device 103 (e.g., through an application that includes one or more tools described above).

In some embodiments, podcast management server 101 may sit between different user devices 103, to allow these user devices 103 to conduct podcast swaps by promoting each other's podcasts. In some embodiments, podcast management server 101 may communicate with other components of the system 100 through a data communication interface(s). For example, user devices 103 may send a podcast to the podcast management server 101 to be processed therein (e.g. adding a tracking prefix or adding a tracking pixel), and/or the podcast management server 101 may send the processed podcast to the podcast platform for podcasting, among other possibilities. Podcast management server 101 may communicate with user devices 103 and podcast platform 117 through several ways, for example, over one or more networks 111.

Networks 111 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or a combination of wireless interfaces. As an example, a network in one or more networks 111 may include a short-range communication channel, such as Bluetooth or Bluetooth Low Energy channel. A wired network may include a wired interface. The wired and/or wireless networks may be implemented using routers, access points, bridges, gateways, or the like, to connect devices in the system 100. The one or more networks 111 may be incorporated entirely within or may include an intranet, an extranet, or a combination thereof. In one embodiment, communications between two or more systems and/or devices may be achieved by a secure communications protocol, such as a secure sockets layer or transport layer security. In addition, data and/or task completion details may be encrypted.

In some embodiments, podcast audience engagement monitoring system 100 may further include one or more network-attached datastores 119. Network-attached datastore 119 may be configured to store data managed by user devices 103, the podcast management server 101, and/or the podcast platform 117 in a cloud environment. Network-attached datastore 119 may store a variety of different types of data organized in a variety of different ways and from a variety of different sources. For example, network-attached datastore 119 may store unstructured (e.g., raw) data, such as audio and video data, or structured data. In addition, each system component may have its own datastore, such as datastore 109 for the podcast management server 101 and datastore (not shown) in the memory 105a/105n for the user device 103.

It should be also noted that, while various devices, server, and podcast platform are illustrated in the podcast audience engagement monitoring system 100 in FIG. 1, it will be appreciated that more or fewer components may be used instead. For example, podcast management server 101 may include a server stack. As another example, network-attached datastore 119 may be not included in the podcast audience engagement monitoring system 100. In addition, in some embodiments, the functions included in each instance of podcast monitoring tools 107a/107n/107o (together or individually referred to as “podcast monitoring tools 107”) in different devices may be the same or different. In one example, different instances of podcast monitoring tools 107 from different devices collaboratively complete one or more functions. For example, user devices 103 may be configured for user interaction, including the podcast preparation, tracking tool configuration, podcast swap campaign definition, swap partner selection, etc. On the other hand, the podcast management server 101 may be configured to implement audience engagement tracking, analysis, and generate recommendations, and communicate with different users to implement podcast swaps. In the following, podcast monitoring tools 107 included in the podcast management server 101, user devices 103, or podcast platform 117 will be described further in detail with reference to specific modules, engines, or components, and their associated functions.

### Specific Implementation

FIG. 2 illustrates example components included in the podcast monitoring tools 107, according to some embodiments of the disclosure. As illustrated, the podcast monitoring tools 107 may include a prefix tracking handling unit 211, a pixel tracking handling unit 213, a feed swap handling unit 215, an analytical engine 217 217, and a recommendation engine 219.

As described earlier, the disclosed system 100 includes one or more tracking tools to monitor podcast related activities such as user engagement. The tracking tools may include a tracking prefix handling unit 211 and a tracking pixel handling unit 213, among other possible tracking tools.

The prefix handling unit 211 is configured to handle prefix-based tracking for a podcast. The tracking prefix disclosed herein may be a short string (e.g., https://xxxx.xxx/track/123ABC) that certain platform providers such as the podcast platform 117 can add to their hosting platforms. This then allows the disclosed system such as the podcast management server 101 to collect data for podcast related user activities without interfering with the content distribution process. These podcast related activities may include but are not limited to downloads, listener demographics, advertisement conversions, user devices, and more. Podcasters can use this valuable data to understand their audience better, measure the effectiveness of their marketing efforts, and tailor their content to their listeners' preferences.

In some embodiments, the tracking prefix disclosed herein may be added to the beginning of a media URL at the RSS feed level. Accordingly, when a listener or subscriber clicks on a podcast episode, the respective podcast app may send a GET request to the episode's media file. In the disclosed podcast audience engagement monitoring system 100, instead of directly sending the request to the host platform (e.g., the podcast platform 117), the request may be directed to the podcast management server 101. The server 101 may then collect the relevant data, such as the listener's IP address, user agent, and timestamp, before redirecting the request to the original media file. According to some embodiments, the tracking process is seamlessly performed without impacting the listener's experience with the actual podcast.

In one specific example, when a user (e.g., a podcaster) signs up for the disclosed system, the user may configure a tracking prefix disclosed herein, which may be added to the podcast hosting platform. Once the user adds the tracking prefix to the hosting platform, the requests made from podcast listeners can be then directed to the disclosed system, which then allows the system to collect data about the podcast listeners' activities.

In some embodiments, to ensure user privacy, all IP addresses of the users may be hushed before saving these IP addresses. In addition, a user may be also given the option to opt in or out of tracking. In addition, modern browsers like Safari, Firefox, and now Chrome are phasing out third-party cookies to protect user privacy. This restriction disrupts traditional methods of cross-site tracking. In the disclosed system, the server-side tracking can allow to fill the gap left by reduced third-party tracking capabilities, making it less affected by the cookie restrictions and user opt-outs. In addition, since the server sits between the user devices and the podcast platforms, the tracking is not platform-limited, but rather can track user engagement from different hosting platforms having different data formats, thereby offering a unified tracking by the disclosed system 100.

In some embodiments, by including a tracking prefix to track podcast related activities, it may allow to get a better understanding of the audience's profile and listenership growth. In the existing podcast hosting platforms, limited functionalities are provided beyond hosting the podcasts. By providing the tracking prefix for listener activity collection and further analysis of these activities as described in detail later, the disclosed system 100 offers a more comprehensive and accurate understanding of listener behavior and preferences.

In some embodiments, the tracking prefix disclosed herein may also allow advertisers to track the success of their podcast ad campaigns. That is, the tracking prefix may provide the supporting evidence in demonstrating a podcast's value to advertisers. In general, advertisers tend to invest in promotion channels when these channels can prove that the return on ad spend is positive. This is especially true of direct-to-consumer brands, which are highly performance-driven. The tracking prefix disclosed herein may allow advertisers to associate a purchase with a podcast download, and thus the prefix based tracking may allow advertisers to evaluate the efficacy of a specific podcast ad campaign based on the tracked activities of the listeners through prefix-based tracking or tracking pixel-based tracking as will be described in detail later.

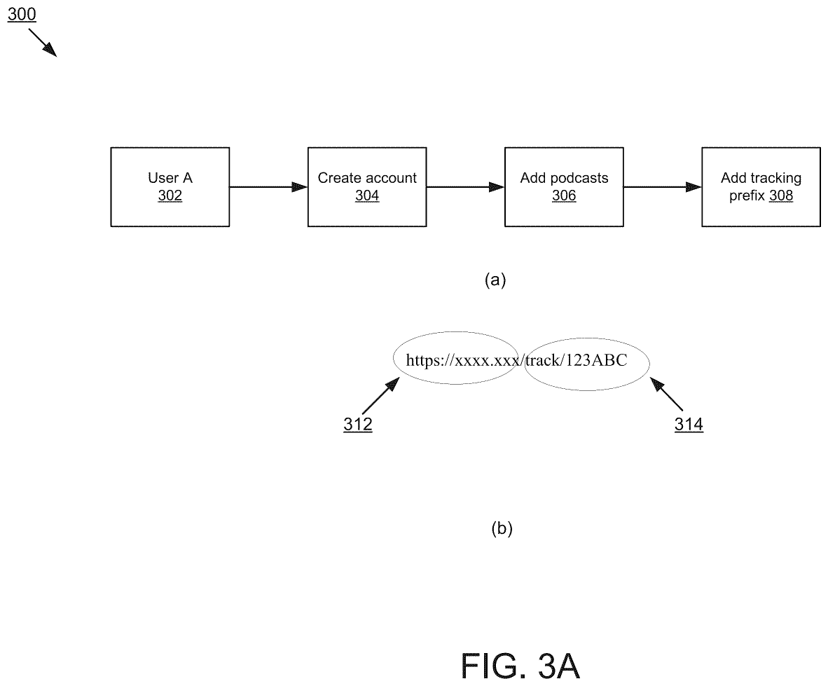

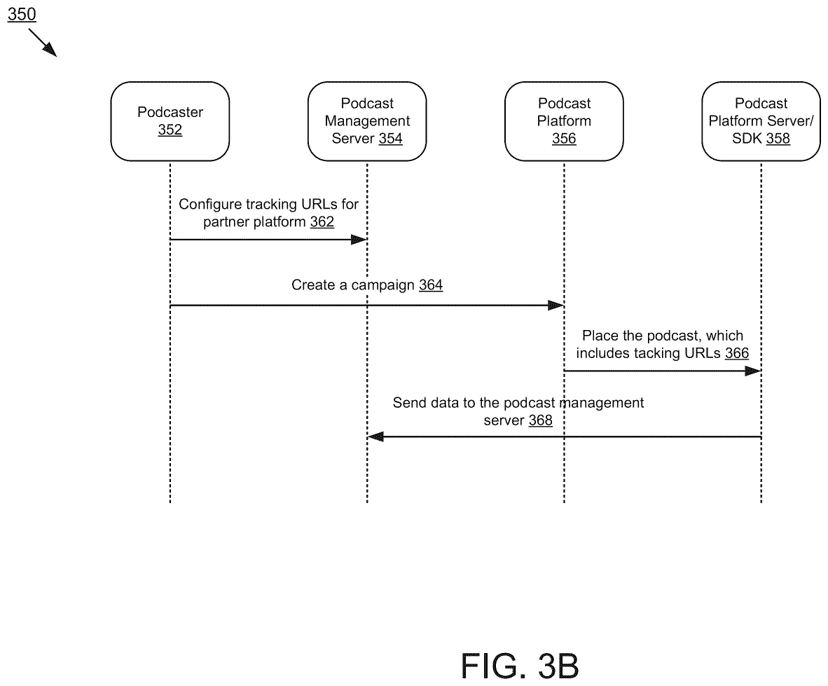

Part (a) of FIG. 3 further illustrates an example process 300 for implementing a tracking prefix in a podcast, according to some embodiments. As shown in FIG. 1, at first, a user A 302 (which may be a podcaster or a publisher) may create an account at step 304 in the disclosed podcast audience engagement monitoring system 100. The account may have an associated account name and password for login by the user A. Upon login, user A may be able to add podcasts for tracking at step 306. For example, user A may create a project for a show (e.g., podcast) that the user A intends to track. To do this, a wizard may be created, which may include a window bar for displaying the feed URL for the to-be-added show. To ensure that the correct feed URL is included, the exact feed URL may be found in the administration section of the hosting platform for the show. In the next, a tracking prefix may be instantly generated based on the provided feed URL. In some embodiments, depending on the podcast hosting platforms identified from the feed URL, different tracking prefixes may be generated for different podcast hosting platforms. That is, a prefix generated for one show hosted by one platform may be different from a prefix generated for another show by another different platform. In some embodiments, a same prefix may be generated for all platforms instead, which is not limited in the present disclosure.

In the next, the generated tracking prefix may be added to the feed URL at step 308, as shown in Part (b) of FIG. 3. As shown in the figure, the generated tracking prefix includes a domain part 312 and a tracking part 314. The domain is the address that receives data about the partner, the campaign, and the user who sees or clicks a podcast or an associated ad. The tracking part is what is added for tracking purposes. In some embodiments, the tracking part may include an event part, which can allow to identify the interaction the user had with the podcast or associated ad. The possible events may include a view or click event, where the view event refers to a case when a user sees the podcast or the associated ad (which is also referred to as “impression”), while the click refers to a case when a user clicks the podcast or the associated ad. The click may lead to a download of the podcast or lead to an opening of a site such as a merchant website associated with the ad. Accordingly, in some embodiments, there are more than one type of tracking prefix, based on the event configured in the tracking part 314. In some embodiments, the tracking part 314 may include additional parameters that specify the data one wants to receive for the campaign. This data might include the user's country, the campaign type, or the goal the one is basing the campaign on.

In some embodiments, a tracking prefix is created based on a template, which uses macros for the parameters so that values can be added later. For example, there may be partner parameters, provided through macro, which are specific to the partner. In some embodiments, what macros one should use for the partner parameters may be identified by consulting partner information for adding to a tracking URL. In some embodiments, other parameters may be managed by the partner platform. For example, the name of the campaign in the partner platform, operating system version, device model, whether the tracking is limited or not, etc. In some embodiments, depending on the hosting platforms, there may be different ways to add the tracking prefix to a specific feed URL.

Once the tracking prefix is added to a feed URL, the associated show may be tracked for user engagement activities. In some embodiments, when a tracking prefix disclosed herein is added to the respective feed URL in the hosting platform, the show may be also added to the podcast list associated with the account of the publisher or podcaster.

FIG. 3B illustrates an example workflow 350 for using tracking URLs in the disclosed system 100. Briefly, a podcaster 352 may configure one or more tracking URLs for a podcast for distribution to the podcast platform 356. The configuration of the tracking URLs may be achieved through the podcast management server 354 disclosed herein. After tracking URL configuration, the podcaster 352 may create a campaign at step 364 to distribute the podcast on the podcast platform 356. The podcast platform 356 then places the podcast including the tracking URLs in the platform through the podcast platform server/SDK 358 at step 366. When there is an audience engagement, the data related to these activities are then sent to the management server 354 at step 368 for further analysis and further generating certain recommendations, as will be described in detail later. It should be noted that, while the tracking URLs are described with reference to podcasts, in some embodiments, the tracking URLs are also applicable to podcast ads for podcast swaps or applicable to other different feeds, which is not limited in the present disclosure.

Referring back to FIG. 2, in some embodiments, the tracking of listener or subscriber activities may be also achieved through a tracking pixel, e.g., through the tracking pixel handling unit 213. A tracking pixel may be considered a technique used on webpages to collect information about the behavior of users. The tracking pixel may have a predefined size (e.g., 1×1 pixel or may have another different size), and may be a transparent graphic that can be built into a respective website or online ad for tracking purposes. In some embodiments, instead of being a transparent graphic, a tracking pixel disclosed herein may be also a pixel tag, web beacon, web bug, clear GIF, or the like. According to some embodiments, the tracking pixel may be hidden in the background of a webpage or online ad so that it does not affect the user experience in interacting with the webpage.

In some embodiments, the tracking pixel disclosed herein may be embedded in the HTML code of a website or online ad and may be retrieved from the server every time a user loads that website or online ad into the web browser. The server may then send the tracking pixel to the user's unique IP address and log it. The server thus can count the number of retrievals. This then allows the tracking of the page view of a website or online ad by the tracking pixel.

In some embodiments, the online ad may be a podcast ad, where an advertisement is added to a podcast (which may be referred to as “a campaign”) so that the ad can reach listeners when the podcast is played. In other words, podcast advertising allows an advertiser to speak directly to potential customers through an audio ad. In some embodiments, a tracking pixel may be similarly added to a podcast ad, similar to an online ad as described above, which then allows to record when a user listens to an advertisement through the podcast.

In some embodiments, a podcast ad may be broadcasted through an ad swapping process, where the two podcasters may exchange podcast ads (i.e., podcasts with ad included therein). The specific processes and functions of podcast swap are further described later. In some embodiments, tracking pixels may be also generated for podcasts under podcast swap (or advertisement swap since an ad is included in the swapped podcasts). For example, when a user agrees to run a swap advertisement with another user, tracking pixels may be generated for each podcast ad. The tracking pixels disclosed herein may be then added to the hosting platforms for tracking purposes. Every time a podcast listener hears an advertisement, a request may be made to the disclosed system to register the action. This tracking allows the disclosed system to track data around advertisement conversions and/or impressions.

In some embodiments, the traffic data collected with a tracking pixel can then be further analyzed, e.g., for marketing purposes or for other purposes. A more accurate analysis of IP addresses can provide a basic idea of where users come from geographically and what type of devices and operating systems the users use to visit a website or online ad. According to some embodiments, the tracking pixel disclosed herein works across various different websites and platforms, giving website owners and advertisers a clearer view of what users are looking for and why they are visiting the site. This data can be used to tailor content and ads to users' needs through targeted marketing campaigns.

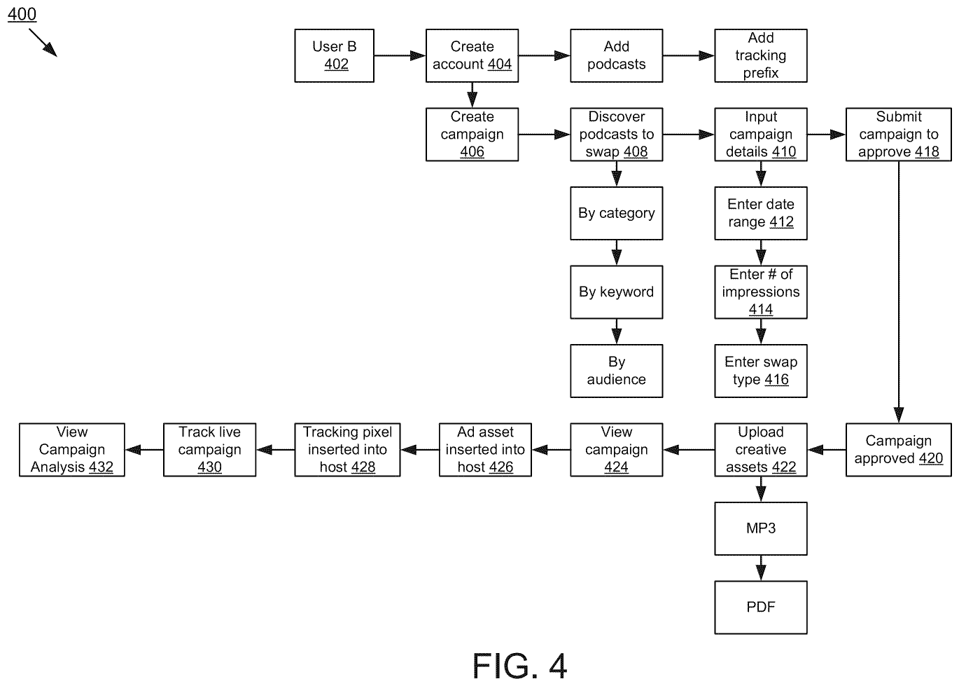

FIG. 4 illustrates an example process 400 for implementing a tracking pixel on a podcast ad, according to some embodiments of the disclosure. Briefly, a user B 402 (which may be an advertiser who intends to broadcast an ad through podcasts) may create an account in the disclosed system 100 at step 404. The user B may then create a campaign at step 406, or a podcast as described earlier. The specific process of the campaign creation may include a first step 408 to discover podcasts to swap with (i.e., to identify a podcast to add an ad), as shown in FIG. 4. In some embodiments, the potential podcasts may be identified based on category (e.g., automotive, books, business, education, food and drink, sports, etc.), keywords, audience, and so on. For example, a sports drink advertiser may hope to broadcast an ad through podcasts related to sports.

As also illustrated in FIG. 4, after a target podcast is identified, campaign details can be further added at step 410. For example, date range 412 may indicate the start date and end date for broadcasting the ad. Number of impressions 414 may indicate the target (or estimated) number of impressions for the podcast ad. Swap type 416 may indicate the type of ad exchange. For example, an ad swap can be an open ad exchange (in which publishers have less control and buyers or advertisers do not have publisher information), a private ad exchange (in which publishers may have control of terms and conditions of the bid for the ad inventory (e.g., a podcast where an ad is added), a preferred deal (in which publishers can sell ad inventory to specific advertisers), or another different type of ad exchange. After these details are defined, the campaign (or an expected podcast ad) may be submitted to the respective entities for approval at step 418. For example, the respective publisher and advertiser may reach an agreement for the defined details.

As further illustrated in FIG. 4, after the campaign is approved at step 420, the creative assets may be uploaded for review at step 422. The creative assets may include a podcast ad, which may be a mp3 file, mp4 file, or another type of file. The creative assets may also include other information (e.g., terms or agreement or others in pdf format). These creative assets may be reviewed at step 424 to ensure everything is correct, for example, a podcast ad plays as expected. If no problem is found, the podcast ad may be published, that is, the ad asset is added to a podcast hosting platform at step 426, as shown in FIG. 4. During the process, a tracking pixel may be also inserted into the hosting platform as described above at step 428. The tracking pixel may track the live campaign (i.e., ad broadcasting to the audiences through the podcast) at step 430. In some embodiments, various additional analyses (e.g., advertisement conversions and impressions) may be further performed based on the tracked data by the tracking pixel. In some embodiments, the results of the analyses may be generated in different formats (e.g., charts, plots, etc.) for view at step 432, as also illustrated in FIG. 4.

It should be noted that, while two tracking tools are described above, in some embodiments, other tracking tools besides the tracking pixel and tracking prefix disclosed herein may be also employed to collect or monitor user activities related to podcasts, online ads, or other formats of digital media, which are not limited in the present disclosure.

Referring back to FIG. 2, in some embodiments, the disclosed system 100 may further include a feed swap handling unit 215 configured to provide feed swap functions such as podcast or promo swap. For example, the feed swap handling unit 215 disclosed herein may be configured to allow two podcasters to promote each other's show. A promo swap may be a short trailer (e.g., 30 seconds or longer or shorter) for promoting another show, which may be placed inside each other's podcast (e.g., at the end of a podcast under the swap). In some embodiments, an actual podcast may be placed inside each other's podcast show with some short notice (which is also referred to as “a podcast swap”).

As a swap, it is generally broadcasted through another show. For example, a promo for podcast B may be broadcasted through podcast A. In some embodiments, a link for the podcast B may be included in the promo note, which helps listeners of the podcast A quickly find and follow the podcast B. In this way, podcasters can advertise to their target audiences for free, since each of the two podcasters may advertise the other's show without requiring paying to the other side. As a cross-promotion or promo swap, podcast swaps may effectively replicate word-of-mouth recommendations or referrals, which is considered one of the most powerful marketing tools. If a podcaster finds a good match, with complementary audiences, a feed swap can be considered a relatively straightforward promotion tool and way of reaching new listeners. In some embodiments, to further improve the efficacy of feed swap, multiple partners may be selected for a single show.

In some embodiments, the promo swap disclosed herein may take different formats. In one example, a promo swap may be a host-read trailer, which means a host that one user partners with will read a promo for the user, and vice versa. In another example, a promo swap may be recorded by the user reading the promo himself/herself, and then sending the recording to the partner, who then uploads the file to his/her show. Other means of advertising or promoting a podcast are also possible and are contemplated in the present disclosure.

In some embodiments, the feed swap handling unit 215 disclosed herein may be configured to create one or more dashboards that facilitate podcast swaps. For example, a dashboard may be created in the disclosed system to show podcasts that users can swap with, wherein the podcasts can be classified into different categories within the marketplace. In one example, users may view all the podcasts connected with the system disclosed herein and request to swap with one of the listed podcasts based on users' interests. In some embodiments, the podcasts in the disclosed system (e.g., in a dashboard) may be broken down into two categories: new and noteworthy/recommended. The former lists podcasts that have recently connected with the system, while the latter lists podcasts based on a recommendation algorithm associated with the system. For example, a recommendation engine 219, as will be described later, may be included in the disclosed system to provide a recommendation of podcasts to be included in the recommended podcasts in the dashboard.

According to some embodiments, the feed swap handling unit 215 disclosed herein may also organize podcasts in the dashboard according to certain characteristics of the podcasts. For example, for enterprise users or users associated with another type of entity, the podcasts may be classified as internal podcasts or external podcasts. For internal podcasts, enterprise users may view all the podcasts that are connected to their accounts. Within their own network, the enterprise users may select multiple podcasts to swap with (e.g., with multiple partners). All of these swaps may be then grouped together in an “internal multi-swap campaign” for internal podcast swaps within the enterprise. For the external podcasts that do not belong to that enterprise, the enterprise users may view all podcasts of other enterprises that have created accounts on the disclosed system. Within the network or marketplace (including that enterprise or other enterprises that have created the accounts), the enterprise users can select multiple podcasts to swap with. All these swaps may be then grouped together in a “multi-swap campaign” for podcast swaps between different enterprises within the network.

In some embodiments, instead of relying on user selection of certain podcasts for swap, the disclosed system may further generate a list of podcasts for swap. For example, the feed swap handling unit 215 disclosed herein may include an artificial intelligence algorithm that can identify a podcaster whose podcasts have audiences complementary to those of another podcaster (and may be also of similar size audiences). The feed swap handling unit 215 may then recommend one podcaster to the other for swap purposes. In some embodiments, an additional analytical engine 217 and/or a recommendation engine 219 may implement these processes and other recommendations related to podcast swap or for other purposes, as will be described in detail below.

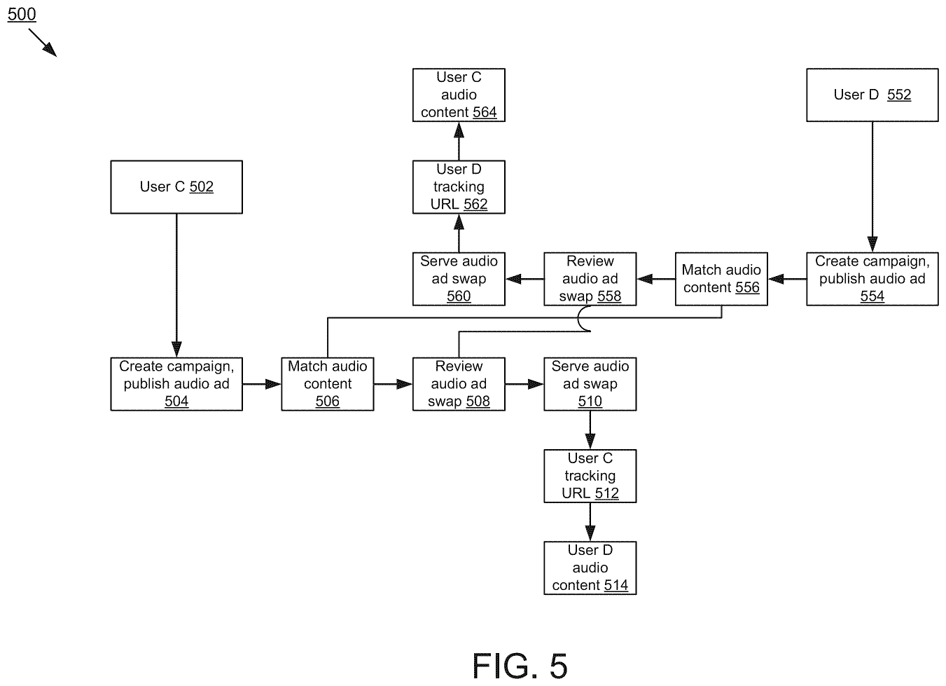

FIG. 5 illustrates an example process 500 for implementing a promo swap, according to some embodiments. As illustrated, two users (e.g., user C and user D) or partners may reach an agreement to promote each other's show through a promo swap, and thus follow a process shown in FIG. 5 to implement the swap. Specifically, for the user C 502, s/he may first create a campaign for publishing the audio (or video) ad at step 504, which is a kind of promo discussed above. In one example, the user C 502 may record a promo or generate a readable document for sending the partner (e.g., user D 552 in FIG. 5) during the process of creating the campaign. In the next, the user C 502 may match the audio content at step 506. By matching the audio content, the user C 502 may find the proper partner that the user C hopes to partner with. For example, the user C 502 may find that audio content of a show from the user D 552 may have complementary audiences, and thus consider that show as a target swap podcast. If the target podcast/partner is determined, the created audio ad from the user C may be forwarded to the partner user D 552 for review. Meanwhile, the user C may review an audio ad swap from the partner user D at step 508. If the user C determines that the audio ad swap prepared by the user D is proper, the user C may proceed with the podcasting process, for example, to serve the audio ad swap at step 510. The specific process of serving the audio ad swap may include a process of adding a tracking prefix to the audio ad swap for tracking purposes at step 512, and placing the audio ad swap into the podcast from the user D for podcasting together at step 514. As can be seen from FIG. 5, during the promo swap, the partner user D 552 may implement a similar process including steps 554-564 in serving the audio as swap created by the user C, thereby achieving an ad exchange or swap.

In some embodiments, the disclosed system may be further configured to generate one or more user interfaces for displaying the effects of swap advertisements or other outcomes (e.g., analysis results generated by an analytical engine 217) caused by swap activities. For example, for the above described swap between user C and user D, the disclosed system may generate a first user interface for user C, where the user interface may be configured to display a lift in listener engagement on podcasts after running the swap with the partner user D. The lift in listener engagement may be displayed through a time series plot in the user interface that shows improved user engagement activities after implementing the podcast swap with the partner user D. Similarly, a second user interface may be generated for user D for displaying a lift in listener engagement on podcasts after running the swap with the partner user C. In some embodiments, if a user has implemented multiple swaps with different users, the disclosed system may be configured to further generate a user interface that allows a comparison of the effects of different swaps. This then allows the user to adjust the swap strategies if necessary, for example, by extending a swap or terminating a swap earlier than expected. Other different user interfaces may be also generated, based on the specific analyses performed by the disclosed system, as further described in detail below.

Referring back to FIG. 2, the disclosed system 100 may further include an analytical engine 217 configured to analyze podcast and related content (e.g., advertisements) usage data to generate certain actionable insights. For example, based on the data collected from the prefix and tracking pixel tools, or from other possible sources (e.g., from data obtained from swapping partners), certain data points may be obtained. Exemplary data points may include but are not limited to delivered impressions, planned impressions, downloads, conversion rates, highest performing partners, highest performing shows, top performing ad creatives, best-performing genres, and so on, all of which may be analyzed by the analytical engine 217 disclosed herein. Depending on the interests of different podcasters, different kinds of analysis can be performed based on the collected data points. Exemplary analyses disclosed herein may include but are not limited to advertisement efficacy analysis, podcast visibility analysis, and audience analysis, etc.

In some embodiments, the results of the analysis may be rendered for display on a user device as graphs, tables, charts, plots, or other different formats. A user, when viewing these results, may quickly get a sense of the podcast and advertisement efficacy. In some embodiments, certain actionable insights may be further generated based on the result analysis, so as to grow an audience of podcasts with podcast visibility optimization. For example, the actionable insights may include adding certain keywords into the metadata to allow others to have a greater chance to find a podcast. Some exemplary analyses are further described in the next.

According to some embodiments, the data analyses disclosed herein may include analyzing the podcast downloads from all possible dimensions to uncover the hidden insights. This may include analyzing the downloads based on the country or region, based on the time (e.g., time of day, week, month, season, or year) of downloading, based on the platforms, browsers, devices, and so on. This may then provide insights on the effect of seasonality, allow to identify visibility (e.g., reached regions), allow to identify the trends (e.g., which kinds of podcasts are hot topics on the last day(s)), allow to identify outliers, etc.

In some embodiments, the analytical engine 217 may also analyze podcasts from other podcasters, which may also provide insights on how to improve the visibility of a podcaster's own podcasts. For example, the analytical engine 217 may identify competitors' podcasts based on the keywords, category/genre, and other possible factors. By analyzing the competitors' highly ranking podcasts, certain actionable insights may be also generated for improving the podcast's own podcasts. For example, the top keywords identified from the competitors' highly ranking podcasts may be added to the podcaster's own podcasts, to improve the search volume of the podcasts for that podcaster.

In some embodiments, the analytical engine 217 may also analyze the data points to understand which paid campaigns and social media posts drive listener growth. For example, the analytical engine 217 may collect data from various related sources to identify which social platforms or channels and/or which campaigns have a higher promotion efficacy. Such analysis may be performed in different granularity, for example, which types of channels or platforms, which specific channel or platform in each type, and even which specific subject in each channel or platform, and so on. These analyses may then provide insights on which platform(s) or channel(s) a podcast should allocate budget.

In some embodiments, the analytical engine 217 may analyze the podcast and relevant content usage data in real-time or near real-time, so that new trends can be caught timely if there is any. For example, the analytical engine 217 disclosed herein may analyze the podcasts and related content usage data every hour, every few hours, every day, or every few days, or whenever there are new activities for a podcast(s) or related content, so that current trends of podcast related activities can be timely identified, and actionable insights may be timely generated and/or updated dynamically for immediate actions.

In some embodiments, the analytical engine 217 may take additional factors into consideration when analyzing user activities. For example, the analytical engine 217 may check whether ad blockers are set up, which can prevent certain scripts from loading, resulting in incomplete or inaccurate data collection. In such a case, the analytical engine 217 may exclude that information from consideration in analysis to make sure the data is not skewed. In some embodiments, the analytical engine 217 may also detect whether there is automated traffic when analyzing user activities. Automated traffic can skew data and lead to inaccurate conclusions. For example, bot activity can inflate metrics like page views, skew bounce rates, and create false conversion events. The analytical engine 217 may filter out such activities to generate more meaningful insights. Other factors affecting analysis accuracy include certain user activities without logging in or providing identifiable information. The analytical engine 217 may then identify these users through other different means (e.g., IP address). In some embodiments, the analytical engine 217 may perform additional analyses not described above, which are also contemplated in the present disclosure.

Referring continuously to FIG. 2, the disclosed system 100 may further include a recommendation engine 219 configured to generate certain recommendations as described earlier. For example, the recommendation engine 219 may recommend the most relevant podcasts to a user, a group of users, or to the general public. In some embodiments, the disclosed system 100 may include an algorithm that is configured to generate recommendations for the user(s). The algorithm may generate podcast recommendations based on a podcast's genre, reach, network, and so on. Using these categories, the algorithm may identify potential target users for that podcast. In some embodiments, the recommended podcast may be added to the target users' recommendation podcasts list. Similarly, for a specific user, based on the podcast view/download history, the categories most interesting to the user may be also identified. Accordingly, the recommendation engine 219 may identify podcasts that may be interesting to the user, and thus generate and provide a recommendation list to the user. The recommendation list may be provided to the user in a user interface that lists a number of recommended podcasts. In some embodiments, the list may be a dynamic list that is frequently updated, since there may be new podcasts that may be interesting to the user after the last check-in by the user.

In some embodiments, the recommendation engine 219 may be further configured to identify the best swap advertisement partners for both parties when the two parties show interest in podcast swap, as described earlier. In some embodiments, the recommendation engine 219 may generate additional recommendations not described above, which are also contemplated in the present disclosure.

In some embodiments, the recommendation engine 219 may include a machine learning model that can be trained to optimize the performance of podcast recommendation or partner recommendation. For example, the machine learning model may be trained to identify a user's interest based on the user's activities. For another example, the machine learning model may be trained to identify a genre of a podcast based on the keywords among other possible factors. In yet another example, the machine learning model may be trained to identify the best swap targets for different parties based on the data of previous campaigns. In some embodiments, the machine learning model may be frequently trained to optimize the performance as time passes by.

### Example Method

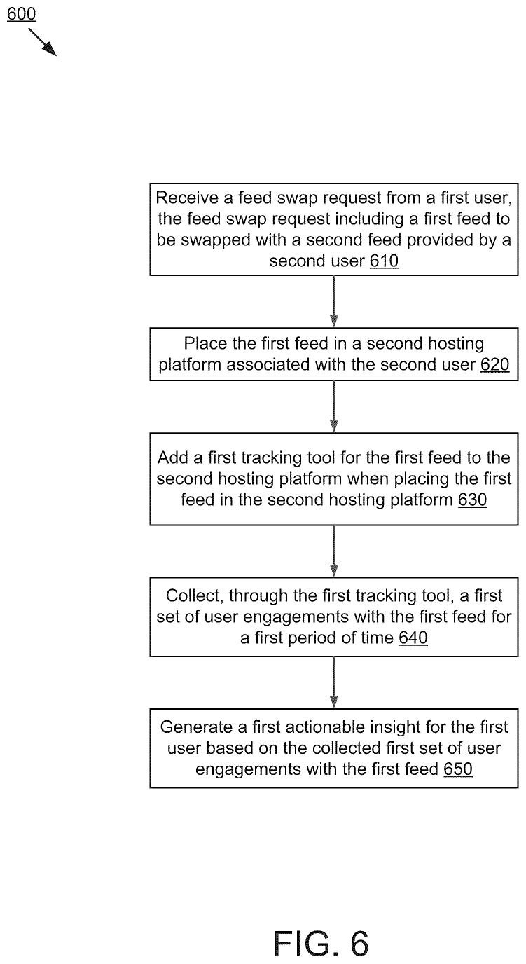

Referring now to FIG. 6, an example method 600 for feed swap is further described.

Step 610: Receive a feed swap request from a first user, the feed swap request including a first feed to be swapped with a second feed provided by a second user.

In some embodiments, the first user and the second user are podcasters who hope to promote their podcasts to reach a larger audience. The first user may prepare a first feed for a swap with the second user. The first feed may be a promo feed which is a promo ad for promoting a podcast or a website containing more than one podcast of the first user. The prom feed may be a short trailer that is recorded by the first user and sent to the second user to be included in the second user's podcast. Alternatively, the promo feed may be a text file that can be read out by the second user in his/her podcast, where the reading out part may be also considered a promo feed for the first user since it promotes the podcast(s) of the first user. In some embodiments, a note for the promo feed may be also placed into the second hosting platform, where the note may include a link to a podcast(s) promoted by the first user in the promo feed. The audience listening to the promo feed may thus have a chance to listen to the podcast promoted through the promo feed.

In some embodiments, the first feed may be actually a podcast of the first user that is directly played through the hosting platform of the second user. In some embodiments, the second user is identified because the audience of the second user is complementary to the audience of the first user.

Step 620: Place the first feed in a second hosting platform associated with the second user.

In some embodiments, in response to the feed swap request from the first user, the first feed is reviewed by the second user. Similarly, a second feed prepared by the second user is also reviewed by the first user. Once approved, the first feed may be placed into the hosting platform of the second user. For example, for a promo feed, it may be included in a podcast of the second user and placed through the hosting platform of the second user. For a podcast feed, it can be added to the podcast list of the second user and placed through the hosting platform of the second user.

Step 630: Add a first tracking tool for the first feed to the second hosting platform when placing the first feed in the second hosting platform.

In some embodiments, when placing the first feed in the second hosting platform, a tracking tool may be also added to the second hosting platform. For example, when the first feed is a podcast feed of the first user, a prefix may be added to the second hosting platform. When users engage with the podcast feed of the first user through the second hosting platform, the user activities can be tracked for further analysis. In some embodiments, user information as well as user device information or operating systems of the users may be also collected and used for analysis. In some embodiments, the first feed may be a promo feed. After the promo feed is added to a podcast of the second user in the second hosting platform, a tracking pixel may be added to the webpage placing the podcast, so that user engagements with the podcast of the second user may be also tracked for further analysis. The analysis may include determining whether the feed swap helps promote the podcast associated with the first feed, and determining whether to switch to a different partner if the outcome is not as expected.

Step 640: Collect, through the first tracking tool, a first set of user engagements with the first feed for a first period of time.

In some embodiments, after the tracking tool is placed, when the audience engages with the first feed, the user activities can be tracked, which can be further analyzed. This includes tracking the user engagements with the promo feed, the podcast feed played through the second hosting platform. In some embodiments, user engagements (e.g. user click of the link included in the note associated with the first feed) with the podcast(s) of the first user associated with the promo feed are also collected and further analyzed.

Step 650: Generate a first actionable insight for the first user based on the collected first set of user engagements with the first feed.

In some embodiments, based on the collected user engagements with the first feed including the promo feed, the podcast feed, the podcast(s) associated with the promo feed, it can be determined whether the feed swap promotes the podcast(s) for the first user, how popular the podcast(s) of the first user, which kind of users are interested in the podcast(s) of the first user, and so on. In some embodiments, based on the analysis, one or more actionable insights can be generated for the first user. For example, one or more keywords may be recommended for the first user to be included in the metadata for easier search. Additionally, or alternatively, one or more keywords may be included in the actual podcasts to increase the popularity of the podcasts of the first user, where these keywords may reflect the current hot topics in the market. In some embodiments, the actional insight may invite the first user to switch partners for feed swaps based on the performance of the feed swap. Other actionable insights are also possible and contemplated in the present disclosure.

### Implementing Device

In some embodiments, the various podcast audience engagement monitoring methods disclosed herein may be implemented on a computing system with access to a hard disc or remote storage, as further described in detail below.

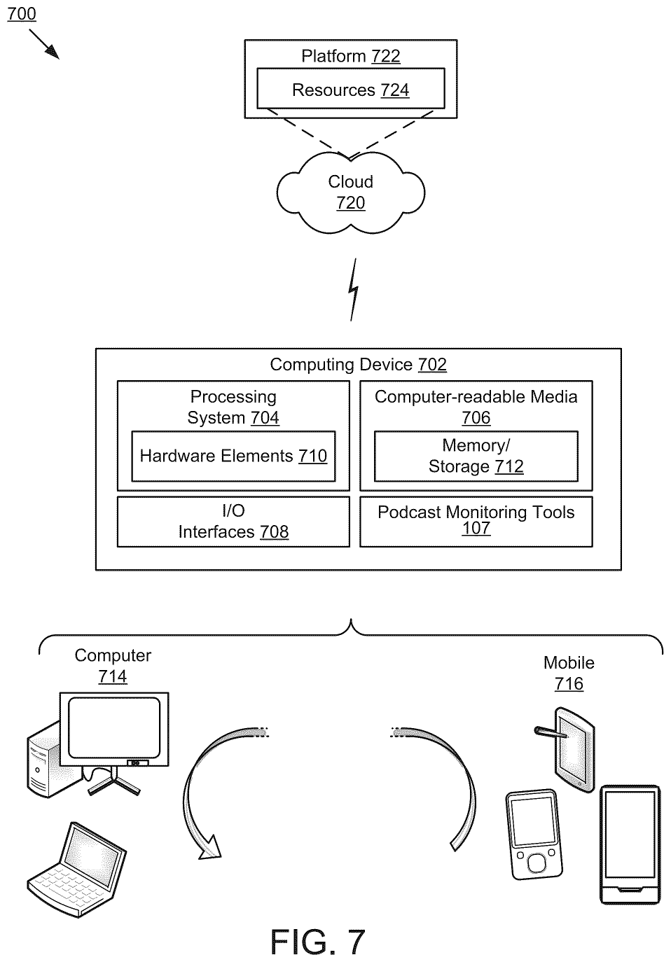

FIG. 7 illustrates an example system 700 that, generally, includes an example computing device 702 that is representative of one or more computing systems and/or devices that may implement the various techniques described herein. The computing device 702 may be, for example, a user device 103, a podcast platform 117, or a podcast management server 101 as shown in FIG. 1, an on-chip system embedded in a device (e.g., IoT), and/or any other suitable computing device or computing system.

The example computing device 702 as illustrated includes a processing system 704, one or more computer-readable media 706, and one or more I/O interfaces 708 that are communicatively coupled, one to another. Although not shown, the computing device 702 may further include a system bus or other data and command transfer system that couples the various components, from one to another. A system bus may include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of the functionality to perform one or more operations using hardware. Accordingly, the processing system 704 is illustrated as including hardware element 710 that may be configured as processors, functional blocks, and so forth. This may include implementation in hardware as an application-specific integrated circuit (ASIC) or other logic devices formed using one or more semiconductors. The hardware elements 710 are not limited by the materials from which they are formed, or the processing mechanisms employed therein. For example, processors may be comprised of semiconductor(s) and/or transistors, e.g., electronic integrated circuits (ICs). In such a context, processor-executable instructions may be electronically executable instructions.

The computer-readable media 706 is illustrated as including memory/storage 712. The memory/storage 712 represents memory/storage capacity associated with one or more computer-readable media. The memory/storage 712 may include volatile media (such as random-access memory (RAM)) and/or nonvolatile media (such as read-only memory (ROM), Flash memory, optical disks, magnetic disks, and so forth). The memory/storage 712 may include fixed media (e.g., RAM, ROM, a fixed hard drive, and so on) as well as removable media, e.g., Flash memory, a removable hard drive, an optical disc, and so forth. The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movements as gestures that do not involve touch), and so forth. Examples of output devices include a display device (e.g., a monitor or projector), speakers, a printer, a network card, a tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “unit,” “component,” and “engine” as used herein generally represent software, firmware, hardware, or a combination thereof. The features of the techniques described herein are platform-independent, meaning that the techniques may be implemented on a variety of commercial computing platforms having a variety of processors.

As previously described, hardware elements 710 and computer-readable media 706 are representatives of modules, engines, programmable device logic, and/or fixed device logic implemented in a hardware form that may be employed in one or more implementations to implement at least some aspects of the techniques described herein, such as to perform one or more instructions. Hardware may include components of an integrated circuit or on-chip system, an ASIC, a field-programmable gate array (FPGA), a complex programmable logic device (CPLD), and other implementations in silicon or other hardware. In this context, hardware may operate as a processing device that performs program tasks defined by instructions and/or logic embodied by the hardware as well as hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of an engine that is executable by the computing device 702 as software may be achieved at least partially in hardware, e.g., through the use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

As further illustrated in FIG. 7, the example system 700 enables ubiquitous environments for providing one or more device-specific AI engines, which can be further personalized. This improves the performance of an AI engine not only due to its compatibility with specific device constraints but also due to its personalized output.

In the example system 700, multiple devices are interconnected through a central computing device. The central computing device may be local to multiple devices or may be located remotely from the multiple devices. In one embodiment, the central computing device may be a cloud of one or more server computers that are connected to multiple devices through a network, the internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a family of target devices is created, and experiences are tailored to the family of devices. A family of devices may be defined by physical features, types of usage, or other common characteristics of the devices.

In various implementations, the computing device 702 may assume a variety of different configurations, such as for computer 714 and mobile 716 uses, and for many enterprise use, IoT user, and many other uses not illustrated in FIG. 7. Each of these configurations includes devices that may have generally different constructs and capabilities, and thus the computing device 702 may be configured according to one or more of the different device classes. For instance, the computing device 702 may be implemented as the computer 714 family of a device that includes a personal computer, desktop computer, multi-screen computer, laptop computer, netbook, and so on. The computing device 702 may also be implemented as the mobile 716 family of devices that include mobile devices, such as a mobile phone, a portable music player, a portable gaming device, a tablet computer, a wearable device, a multi-screen computer, and so on. In some embodiments, the devices may be classified according to their constraints instead, as described earlier.

The techniques described herein may be supported by these various configurations of the computing device 702 and are not limited to the specific examples of the techniques described herein. This is illustrated through the inclusion of podcast monitoring tools 107 on the computing device 702, where the podcast monitoring tools 107 may include different units or modules as illustrated in FIGS. 1-6. The functionality represented by the podcast monitoring tools 107 and other modules/applications may also be implemented all or in part through the use of a distributed system, such as over a “cloud” 720 via a platform 722 as described below.

The cloud 720 includes and/or is representative of platform 722 for resources 724. The platform 722 abstracts the underlying functionality of hardware (e.g., servers) and software resources of the cloud 720. Resources 724 may include applications and/or data that can be utilized while computer processing is executed on servers that are remote from the computing device 702. Resources 724 can also include services provided over the internet and/or through a subscriber network, such as a cellular or Wi-Fi network.

The platform 722 may abstract resources and functions to connect the computing device 702 with other computing devices 714 or 716. The platform 722 may also serve to abstract the scaling of resources to provide a corresponding level of scale to encountered demand for the resources 724 that are implemented via platform 722. Accordingly, in an interconnected device implementation, the implementation functionality described herein may be distributed throughout system 700. For example, the functionality may be implemented in part on the computing device 702 as well as via the platform 722 which abstracts the functionality of the cloud 720.

### Additional Considerations

While this disclosure may contain many specifics, these should not be construed as limitations on the scope of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Under certain circumstances, multitasking and parallel processing may be utilized. Moreover, the separation of various system components in the implementations described above should not be understood as requiring such separation in all implementations, and it should be understood that the described program components and systems may generally be integrated together into a single software or hardware product or packaged into multiple software or hardware products.

Some systems may use certain open-source frameworks for storing and analyzing big data in a distributed computing environment. Some systems may use cloud computing, which may enable ubiquitous, convenient, on-demand network access to a shared pool of configurable computing resources (e.g., networks, servers, storage, applications, and services) that may be rapidly provisioned and released with minimal management effort or service provider interaction.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

What is claimed is:

1. A computer-implemented method, comprising:
receiving a feed swap request from a first user, the feed swap request including a first feed to be swapped with a second feed provided by a second user;
placing the first feed in a second hosting platform associated with the second user;
adding a first tracking tool for the first feed to the second hosting platform when placing the first feed in the second hosting platform;
collecting, through the first tracking tool, a first set of user engagements with the first feed for a first period of time; and
generating a first actionable insight for the first user based on the collected first set of user engagements with the first feed.

2. The computer-implemented method of claim 1, further comprising:
placing the second feed in a first hosting platform associated with the first user;
adding a second tracking tool for the second feed to the first hosting platform after placing the second feed in the first hosting platform;
collecting a second set of user engagements with the second feed for a second period of time based on data collected through the second tracking tool; and
generating a second action insight for the second user based on the collected second set of user engagements with the second feed.

3. The computer-implemented method of claim 1, wherein the first tracking tool is a tracking pixel added to a first webpage for broadcasting the first feed hosted by the second hosting platform.

4. The computer-implemented method of claim 1, where the first feed is a trailer added to a podcast of the second user when placing the first feed in the second hosting platform.

5. The computer-implemented method of claim 4, wherein the feed swap request further includes a note for the first feed, the note including a link to a podcast of the first user promoted through the first feed.

6. The computer-implemented method of claim 5, wherein the podcast of the first user promoted through the first feed is hosted by a first hosting platform.

7. The computer-implemented method of claim 6, wherein the podcast of the first user promoted through the first feed further includes an associated second tracking tool.

8. The computer-implemented method of claim 7, wherein the second tracking tool is a tracking prefix placed directly in an RSS feed for the podcast of the first user promoted through the first feed.

9. The computer-implemented method of claim 1, wherein the first feed includes a podcast of the first user played through the second hosting platform.

10. The computer-implemented method of claim 9, wherein the podcast of the first user played through the second hosting platform further includes an associated second tracking tool.

11. The computer-implemented method of claim 10, wherein the second tracking tool is a tracking prefix placed directly in an RSS feed for the podcast of the first user played through the second hosting platform.

12. The computer-implemented method of claim 1, further comprises:
collecting additional user information for one or more users associated with the first set of user engagements; and
generating the first actionable insight for the first user based also on the additional user information.

13. The computer-implemented method of claim 1, wherein generating the first actionable insight comprises adding one or more keywords to metadata for one or more podcasts associated with the first user.

14. The computer-implemented method of claim 1, wherein generating the first actionable insight comprises including one or more keywords in one or more podcasts associated with the first user.

15. The computer-implemented method of claim 1, wherein the second user is identified by a machine learning model based on an audience of the first user and an audience of the second user.

16. The computer-implemented method of claim 1, further comprising identifying one or more relevant podcasts for the first user based on a genre, reach and network of a podcast of the first user.

17. A system, comprising:
a processor; and
a memory, coupled to the processor, configured to store executable instructions that, when executed by the processor, cause the processor to perform operations comprising:
receiving a feed swap request from a first user, the feed swap request including a first feed to be swapped with a second feed provided by a second user;
placing the first feed in a second hosting platform associated with the second user;
adding a first tracking tool for the first feed to the second hosting platform when placing the first feed in the second hosting platform;
collecting, through the first tracking tool, a first set of user engagements with the first feed for a first period of time; and
generating a first actionable insight for the first user based on the collected first set of user engagements with the first feed.

18. The system of claim 17, wherein the operations further comprise:
placing the second feed in a first hosting platform associated with the first user;
adding a second tracking tool for the second feed to the first hosting platform after placing the second feed in the first hosting platform;
collecting a second set of user engagements with the second feed for a second period of time based on data collected through the second tracking tool; and
generating a second action insight for the second user based on the collected second set of user engagements with the second feed.

19. The system of claim 17, wherein the first tracking tool is a tracking pixel added to a first webpage for broadcasting the first feed hosted by the second hosting platform.

20. The system of claim 17, where the first feed is a trailer added to a podcast of the second user when placing the first feed in the second hosting platform or a podcast of the first user played through the second hosting platform.
